(19) United States
(12) Patent Application Publication
(10) Pub. No.: US 2023/0120229 A1
(43) Pub. Date: Apr. 20, 2023

(54) DEPTH FILTERS AND RELATED METHODS

(71) Applicant: ENTEGRIS, INC., Billerica, MA (US)

(72) Inventors: Maybelle Woo, Dedham, MA (US); Jeffrey E. Townley, Townsend, MA (US)

(21) Appl. No.: 17/966,604

(22) Filed: Oct. 14, 2022

Related U.S. Application Data
(60) Provisional application No. 63/256,945, filed on Oct. 18, 2021.

(51) Int. Cl. B01J 20/10; B01J 20/26; B01J 20/20; B01J 20/28; B01J 20/30; B01D 46/00; B01D 39/16; B01D 39/20

(52) U.S. Cl. CPC B01J 20/10; B01D 39/163; B01D 39/2062; B01D 39/2079; B01D 46/0001; B01D 46/0036; B01J 20/20; B01J 20/262; B01J 20/267; B01J 20/2803; B01J 20/3007; B01J 20/28035; B01J 20/28038; B01D 2239/10; B01D 2239/065; B01D 2239/083; B01D 2239/0407; B01D 2239/0618; B01D 2275/10

(57) ABSTRACT

Described are multi-layer filters of a type commonly known as “depth filters” and related devices and methods, with the filters containing a layer that includes polyaramid fiber, synthetic filter aid, and polymeric binder.

### CROSS-REFERENCE TO RELATED APPLICATION

This application claims the benefit under 35 USC 119 of U.S. Provisional Pat. Application No. 63/256,945, filed Oct. 18, 2021, the disclosure of which is hereby incorporated herein by reference in its entirety.

### FIELD

The description relates to multi-layer filters of a type commonly known as “depth filters” and related devices and methods, with the filters containing a layer that includes polyaramid fiber, synthetic filter aid, and polymeric binder.

### BACKGROUND

Filters of the type referred to as “depth filters” are useful in filtration methods for removing solids from a liquid, when the liquid contains solids having a range of sizes. In one application, depth filters are known for methods of clarifying cell cultures, which contain differently-sized solid materials suspended in a liquid, to isolate a high value “target” molecule that is also contained in the cell culture.

Common varieties of depth filters include a stack of multiple separately-prepared filter layers, with each layer having a thickness or “depth.” A liquid, for example a liquid cell culture, is passed in series through the stack of filter layers. The filter retains solid materials that are suspended in the liquid and separates those materials from the liquid. Filtering the liquid is believed to involve both a sieving mechanism based on size-exclusion, and a non-sieving (adsorption) mechanism based on hydrophobic, ionic, or another chemical or electrostatic interaction that attracts a particle or dissolved molecule within the liquid to a component of the depth filter.

Relevant to the size-exclusion mechanism, the filter stack contains multiple layers, and the layers are arranged in the stack to have progressive filtering effects in the direction of the depth of the stack. Layers that contain larger pore sizes are positioned as “upstream” layers at upper portions of a filter stack, meaning layers that first contact a liquid passing through the stack. Layers that contain smaller pore sizes are located at downstream locations so that liquid that flows through the stack contacts the “downstream” layers after contacting the upstream layers. The depth filter retains solid materials that have a range of larger and smaller particle sizes by retaining larger particles at upstream layers and by retaining smaller particles at downstream layers of the filter stack.

One effective use of a depth filter is for clarifying a cell culture. A step of clarifying a cell culture has the effect of removing solid or dissolved materials from the cell culture, which also contains a dissolved high-value material. Cell cultures are liquids that contain cellular materials suspended or dissolved in the liquid, including commercially valuable non-solid materials dissolved in the liquid. The desired dissolved material is sometimes referred to as a “target molecule,” a “high-value target molecule,” or the like. The depth filter is effective to separate solid materials of the cell culture from the liquid solution of the cell culture that contains the target molecule, so that the liquid solution can be further processed to isolate and purify the target molecule. A depth filter can also remove undesired dissolved materials such as non-target molecules, DNA, and host cell proteins, through adsorption.

The solid materials of the cell culture include cells, cell debris, and cell components, which have a range of particle sizes. The depth filter removes a high percentage of the solid materials from the liquid while allowing the liquid and dissolved non-solid materials, especially high value target molecules, to pass through the depth filter.

The layers of commercial depth filters include fiber (such as naturally-derived cellulose fibers), filter aid (such as a particles of a naturally-occurring material such as diatomaceous earth (DE)), and a polymer resin that acts to hold the fibers and the particles together as a layer of a depth filter.

A known disadvantage of many depth filters is the presence of impurities that are present within materials of a depth filter, and that can become contaminants in a liquid that is passed through the filter for filtration. Natural (non-synthetic) materials used as materials of a depth filter include materials such as cellulose fibers and diatomaceous earth filter aid. These and other natural materials used in depth filters will contain trace amounts of impurities. Natural cellulose fibers, which are very commonly used in depth filters, contain beta glucans. Diatomaceous earth contains extractable metals.

Any impurities that are present in a material of a depth filter (e.g., in a natural fiber or a natural filtering aid) can become extracted from the material during use of the filter, by a liquid that is passed through the filter. The impurity may be extracted into and carried by the liquid (the “filtrate” or “filtrate solution”) that has passed through the depth filter as an extracted, dissolved contaminant in the liquid. In biotechnology applications, such contaminants in a filtrate solution are of course unwanted. Any contaminant in a filtrate solution may interfere with subsequent processing (e.g., purification) of the filtrate solution to isolate and purify a high value target molecule in the filtrate solution.

As a different drawback, natural materials such as diatomaceous earth and other natural filter aids (e.g., perlite) are naturally-occurring materials, and have variable compositions. The variability may be significant.

### SUMMARY

Described are depth filters and related devices and methods. The depth filters include one or more layers that contain polyaramid fiber, synthetic filter aid, and polymeric binder. In general, and in specific applications of using a depth filter for filtering liquid cell cultures, a need exists for filter materials that contain reduced amounts of extractable impurities that may be extracted and become a contaminant in a liquid filtrate produced in a filtration process. Separately or in combination, a need exists for materials of filter media, e.g., depth filters, that have improved compositional uniformity, and a lower degree of compositional variability.

One way to avoid extractable impurities and variability of ingredients of depth filters is to avoid ingredients that are naturally derived, and to use instead ingredients that are prepared synthetically. U.S. Pat. Publication 2020/0129901 describes a depth filter that includes polyacrylic fiber and silica filter aid. While the fiber is synthetic and does not contain beta-glucans, silica (although synthetic), is known to leach into the process fluid flowing through the filter, which is undesirable.

Additionally, the filtration industry is moving toward the use of closed filtration systems that include filter media (a stack of depth filters) pre-contained in an enclosed filter cartridge. Desirably, the cartridge is pre-sterilized. Traditional methods of sterilizing components of depth filters include moist heat (steam), dry heat, ethylene oxide gas, and radiation. Many depth filter products in cartridge form (in the form of a housing that contains multiple stacked layers of a depth filter) cannot be sterilized using high temperature, either because filter media or a plastic filter housing is not sufficiently temperature stable. Ethylene oxide gas is not always effective for sterilizing a filter cartridge due to the complexity of a flow path through a depth filter-containing cartridge, which can prevent the ethylene oxide gas from easily penetrating and reaching all portions of a filter for sterilization. Radiation, particularly gamma radiation, is the most simple to implement, but cellulose and polyacrylic materials are not stable to gamma radiation.

Presented in the following description are depth filter products that contain filter media in the form of a stack of depth filter layers, with filter media and the layers thereof containing synthetic polyaramid fibers and synthetic filter aid. The synthetic fiber and synthetic filter aid each contain a low level of extractables, and each has a relatively consistent composition.

The polyaramid fibers, as well as other components of the depth filter, are gamma-stable. By one technique, depth filters or depth filter constituents are sterilized by being irradiated with gamma radiation, typically at a dose of from 25 to 40 kGy. A material of a depth filter as described is considered “gamma-stable” if the material can be exposed to an amount of gamma radiation in this dosage range and still be effective as part of a depth filter. The gamma-stable material will retain physical properties, and will not have negative performance attributes from exposure to the gamma-radiation. A depth filter that includes filter layers as described, contained in an enclosed cartridge, may be sterilized in the form of the cartridge, as a step of manufacturing the cartridge; i.e., the cartridge may be sterilized or “pre-sterilized” by exposing the cartridge (with filter media) to a sterilizing amount of gamma-radiation, e.g., from 25 to 40 kGy.

In one aspect the disclosure relates to a depth filter that includes two or more filter layers in series. At least one layer includes: polyaramid fiber, synthetic filter aid, and polymeric binder.

In another aspect the disclosure relates to a method of forming a wet-laid filter material. The method includes: forming a slurry comprising aqueous liquid, polyaramid fiber, synthetic filter aid, and binder, suspended throughout the aqueous liquid; forming a wet slurry layer from the slurry; and removing the aqueous liquid from the wet slurry layer to form a dewatered wet-laid filter material, which is subsequently dried.

### BRIEF DESCRIPTION OF THE FIGURES

FIG. 1 schematically shows an example of a depth filter as described.

FIG. 2 shows filtering performance data of a filter of the present description, compared to a prior art filter.

FIG. 3 shows filtering performance data of a filter of the present description, compared to a prior art filter.

FIGS. 4 through 11 show filtering performance data of example filters of the present description and comparable commercial filters.

### DETAILED DESCRIPTION

The following describes multi-layer filters of the type referred to as “depth filters,” and related devices and methods. The described filters include multiple layers, including one or more layers that contain polyaramid fiber, synthetic filter aid, and polymeric binder.

A depth filter is a filter product characterized by a multi-layer arrangement of fiber-based filtration materials. The multi-layer arrangement includes a stack of multiple filter layers that have different filtering properties, especially different pore sizes, with the stack being arranged to position filter layers that have larger pore sizes as “upstream” layers that are contacted first by a liquid that passes through the depth filter. Layers that contain smaller pore sizes are located at downstream locations so that as the liquid flows through the stack the liquid contacts the upstream layers first and the downstream layers after contacting the upstream layers. As the liquid passes through the depth filter, solid materials in the liquid that have different particle sizes are removed by different layers of the stack, at different depth locations within the stack. The stack generally retains larger particles at the upstream layers and retains smaller particles at the downstream layers.

In other words, the layers of the depth filter become progressively more dense and have smaller pores going from upstream filter layers to downstream filter layers. Solid particle materials that are suspended in a liquid that is flowed through the stack penetrate to varying depths within the stack depending on particle size of the solid particles. This causes the particles that are removed from the liquid and retained by the filter to be distributed throughout the depth of the stack of filter layers, which allows for a reduced buildup of pressure drop across the filter during use, which extends the useful life of the depth filter.

The multiple layers are ordinarily contained in a housing that holds the layers in position and guides a flow of liquid fluid through the stacked filter layers in series, i.e., one-after the other, with the liquid passing first through upstream layers and passing subsequently through downstream layers. Each layer has two opposed surfaces. An upstream surface of each layer (other than the first layer) faces a downstream surface of the preceding layer. The “stacked” layers may contact each other, or the layers may be stacked and positioned to leave a small space (or “air gap”) between upstream and downstream surfaces of adjacent layers. The housing also contains sufficient headspace upstream of the first layer to allow the fluid to uniformly pass through the multiple layers. Example housings are sometimes referred to as cartridges, capsules, boxes, cassettes, columns, and the like.

The housing may be re-usable or may be disposable. With a disposable housing, the stack of filter layers is contained in the enclosed housing for convenient use by installing the housing into a location of a flow of liquid to be filtered. The housing and contained filter layers can be used a single time to remove materials from the flow of liquid, for a single period of use after which the housing and contained filter layers are discarded together. Neither the filter layers nor the housing are used again.

A housing may be made of any useful material such as a metal (e.g., stainless steel or aluminum), a polymer such as high-density polyethylene, polyvinyl chloride, polystyrene, polypropylene, or another material such as glass or ceramic. The housing will include or be connectable to a fluid inlet that is upstream from the filter layers and a fluid outlet that is downstream from the filter layers.

The depth filter is desirably sterilized before being used to filter a liquid. Filter layers may be sterilized by various sterilization techniques, which include: exposure to radiation (gamma radiation), exposure to ethylene oxide, and exposure to steam. However, many housing materials are not stable at high temperatures required for steam sterilization. Also, certain types of fiber materials used in depth filters are not stable to gamma radiation. Ethylene oxide is not always capable of contacting all portions of an interior of a depth filter cartridge that contains a stack of filter layer assembled inside of a housing.

For depth filters of the present description, which include polyaramid fiber, which is gamma-radiation stable, a preferred sterilization technique is to assemble the filter layers as a stack within a filter housing and to sterilize the assembled stack and housing together by exposing the stack and housing to a sterilizing amount of gamma radiation. Because both the housing and the stack of filter layers are stable to gamma radiation, the housing and the filter layer stack can be assembled into a finished, housed, depth filter product and the assembled product can be sterilized by a single gamma radiation step. If other layers or materials are present in the assembled depth filter, such as a non-woven layer, gasket, or the like, the other layers or materials are preferably also stable to gamma radiation.

Depth filters are known for filtering liquid materials that include combinations of suspended particles and dissolved chemical materials, with the particles having a range of different sizes. In a particular use, depth filters are effective for clarifying biological (e.g., biopharmaceutical) fluids such as cell cultures, which contain suspended particles having a range of sizes. As used herein the phrase “cell culture” is a liquid that contains cells, cell debris, at least one biomolecule of interest (the “target molecule), and other undesirable biomolecules such as host cell protein (HCP), and DNA.

The term “clarifying” or “clarification” refers to one or more steps used initially for isolating a target molecule from a cell culture. A clarification step generally involves removal of cells, cellular debris, or both, from the cell culture using one or more steps that may include centrifugation and depth filtration, tangential flow filtration, microfiltration, precipitation, flocculation, and settling. A clarification process may include two separate clarification steps: a primary clarification step that uses a “primary” depth filter, upstream from a secondary clarification step that uses a “secondary” depth filter.

The clarification step produces a liquid “filtrate” or “filtrate solution” that contains the target molecule, with many of the cells and cellular debris originally present in the cell culture having been removed by the clarification step. The filtrate can be further processed to isolate and concentrate the target molecule by any useful techniques. One example of a useful technique may be referred to as a “capture step,” which refers to a method used for binding a target molecule with a chromatography resin, which results in a solid phase that contains a precipitate of the target molecule and the resin. Typically, the target molecule is subsequently recovered using an elution step, which removes the target molecule from the solid phase, thereby resulting in the separation of the target molecule from the original cell culture.

A cell culture is a combination of liquid and solid materials that is derived from a host cell, for example a mammalian cell type, E. coli, yeast cell, insect, or plant. A target molecule of a cell culture can be a polypeptide or other material of interest, which is desired to be purified or separated from one or more undesirable materials that are present in the cell culture. The cell culture also contains solids, sometimes referred to as “contaminants” or “debris,” some of which are also derived from the cell, examples including biological macromolecules such as a DNA, RNA, one or more host cell proteins, endotoxins, viruses, lipids, and one or more additives which may be present in a sample containing a protein or polypeptide of interest (e.g., an antibody). A “host cell protein” is a protein, other than a target protein, found in a lysate of a host cell and in a cell culture. A host cell protein is generally present as soluble or insoluble material in a cell culture medium or lysate (e.g., a harvested cell culture fluid containing a protein or polypeptide of interest (e.g., an antibody or immunoadhesion expressed in a host cell)). A specific example of a type of cell culture is a solution derived from Chinese hamster ovary cells.

Depth filters generally include filter layers that are made using fiber, filter aid, and water-soluble thermoset binder. The fiber provides a network to support the filter aid. The filter aid provides a porous structure and high surface area for adsorption of impurities. The binder functions to bond the materials together with desired mechanical strength. A binder may also impart a negative charge on the structure of the filter, which can increase the ability of the filter to adsorb ionically-charged impurities.

Examples of useful depth filters as described include one or more layers that are made to include polyaramid fiber, synthetic filter aid, and polymeric binder.

Polyaramid fibers are synthetic, and are different from natural fibers and from other synthetic fibers previously used for depth filters. Polyaramid is different from natural fibers such as cellulose, which is commonly used in depth filters, but which contains extractable materials such as beta-glucans. Polyaramid fibers are also different from other synthetic fibers, such as polyacrylic fibers, because polyaramid fibers are stable to gamma-radiation. Being stable to gamma-radiation, polyaramid fibers can be processed by a sterilization process that exposes the fibers to a sterilizing amount of gamma radiation.

Two example types of polyaramid fibers are fibers made from para-aramid (polyparaphenylene terephthalamide), and fibers made from meta-aramid (polymetaphenylene isophthalamide). The para-aramids include those sold under the trade names of Kevlar® (trademark of DuPont) and Twaron® (trademark of Teijin Limited, Osaka, Japan). Meta-aramids are commonly referred to by trade names Nomex® (DuPont) and Teijinconex® (Teijin Limited - often referred to as Conex®).

The polyaramid fibers may comprise, consist of, or consist essentially of polyaramid. Some fibers may be coated or treated at a surface with a material that is different from the polyaramid. Others consist of or consist essentially of polyaramid. According to the present description, a material, ingredient, or structure (e.g., a fiber) that consists essentially of one or more specified materials contains the one or more materials and not more than an insubstantial amount of any other materials, e.g., not more than 5, 1, or 0.1 percent by weight of any other materials. Polyaramid fibers that consist essentially of polyaramid contain polyaramid and not more 5, 1, or 0.1 percent by weight of any other materials.

Individual polyaramid fibers (sometimes referred to herein as “fiber strands”) have size features and physical properties that are effective for use in a layer of a depth filter, when the fibers are used as a collection of many fiber strands in a layer. Useful physical size and shape properties of individual fiber strands useful in a layer of a depth filter are understood. Generally, fibers that are useful in a depth filter are elongated strands having a length, a diameter along the length, and may optionally be fibrillated. The length may be any useful length, such as a length in a range from about 0.01 mm to about 1.7 mm, e.g., from about 0.05 mm to about 1.2 mm.

Polyaramid fibers may optionally be fibrillated. A filter layer as described may include fibers that are fibrillated, fibers that are not fibrillated, or a combination of fibrillated and non-fibrillated fibers.

Fibrillated fibers and the use of fibrillated fibers as a material of a filter layer are known. A “fibrillated fiber” is a fiber that is frayed or split along its length, or a fiber wherein the ends are split and splayed out, resulting in multiple fibrils extending from a larger core fiber. The smaller and thinner fibers or fibrils formed on the core fiber by the fraying or splitting are known as “fibrillae.” The fibrillated fibers include a principal (“core”) fiber body with separate but smaller fibril branches (or “arms” or “limbs”) that are attached at a fibril branch root to the core fiber body.

The fibril branches can affect the ability of a fiber matrix to retain filter aid particles in a filter layer; the finer the fibrils of a fiber matrix, the better able the matrix is to retain smaller filter aid particles during a wet-laying process. The fibril branches can also affect filtration properties of the filter layer by reducing pore size of a filter layer, which may affect filtration properties that are based on a sieving filtration (size-exclusion) rate of flow through the filter layer. The fibril branches may also affect filtration properties of the filter layer by enhancing non-sieving filtration effect (e.g., ionic or hydrophobic adsorption mechanisms) of the fibers.

The degree of fibrillation of the fibers can be measured in terms of Canadian Standard Freeness (CSF) or the drainage rate for a dilute suspension of the fibers. More highly fibrillated fibers tend to have a lower CSF. The preferred CSF ranges from 10 mL to 800 mL; in some embodiments, a range of 600 mL to 750 mL is used. In other embodiments, a range of 200 mL to 600 mL is preferred. In still other embodiments, a range of 50 mL to 300 mL is preferred. In yet other embodiments, fibrillated fibers with different CSF can be combined to produce an average CSF in the range of 10 mL to 800 mL.

An amount of fiber in a filter layer may be an amount that is desired to provide a desired filtering effect based on a position of the layer along a depth of a stack of layers of a depth filter. Fiber may be present in a filter layer in an amount in a range from 20 to 100 weight percent fiber based on total weight fiber and filter aid, e.g., from 30 to 80 or 99.5 weight percent fiber based on total weight fiber and filter aid.

These amounts vary depending on whether the filter layer is part of a primary filter or a secondary filter, and also whether the filter layer is upstream or downstream in a depth filter. Layers of primary filters will have a higher amount of fiber per total amount of fiber and filter aid. For example, layers of a primary filter may have from 40 to 100 weight percent fiber, based on total weight fiber and filter aid in the layer. Layers that are located upstream in a primary depth filter stack will have higher amounts of fiber, and layers that are located downstream in the stack will have lower amounts of fiber.

Layers of secondary filters will have lower amounts of fiber per total amount of fiber and filter aid. For example, layers of a secondary filter may have from 20 to 60 weight percent fiber, based on total weight fiber and filter aid in the layer. Layers that are located upstream in a secondary filter stack will have higher amounts of fiber, and layers that are located downstream in the stack will have lower amounts of fiber.

Synthetic filter aids are synthetic particles that are included in a filter layer to retain a material of a liquid that passes through the filter layer. The filter aid may attract and retain the material of the liquid either mechanically or non-mechanically (adsorptively), e.g., by a sieving or a non-sieving mechanism, and thereafter maintain contact with the material to prevent the material from passing through the filter layer.

A filter aid that is synthetic is made of material that is synthetically produced as opposed to filter aids that are naturally derived. Synthetic filter aids are preferred in a depth filter of the present description because synthetic filter aids contain lower amounts of “leachable” or “extractable” impurities, meaning impurities in the filter aid that can be transferred from the filter aid into a liquid that passes through the depth filter. Filter aids such as diatomaceous earth and perlite contain impurities such as leachable (extractable) metals, which may transfer to a liquid that contacts the filter material. Silica, while synthetic, may also be less-preferred as a filter aid, because silica may potentially leach from silica filter aid particles into a fluid passing through the filter.

Examples, of synthetic filter aids include silica, alumina, glass, other metal oxides or mixed-metal oxides, ion-exchange resins, silicates, and carbon. Currently preferred synthetic filter aids for depth filters of the present description include metal silicates such as magnesium silicate and calcium silicate, and activated carbon.

The synthetic filter aid can be in the form of particles that exhibit any of a variety of useful shapes and sizes. Example filter aid particles may be spherical, fibrous, plate-like, or irregular. The particles may be prepared by steps that include milling, grinding, blending, sieving, or by other techniques that are effective to produce particles of a desired size or a regular or irregular shape.

The synthetic filter aid particles can have desired size properties, such as average size, size distribution, or both. Typical sizes of filter aid particles used in a layer of a depth filter may be in a range from about 5 µm to about 300 µm. The larger-size particles are included in filter layers that are located at upstream locations and the smaller-size particles are included in filter layers located at downstream locations. For example, a first upstream layer of a primary depth filter may have filter aid particles having an average size in a range from 10, 50, or 100, up to 300 µm. A final downstream layer of a primary depth filter or of a secondary depth filter may have filter aid particles having an average size in a range from 5 to 50 µm. Layers between the first upstream layer and the final downstream layer will have particles of successively smaller average particle size.

The filter aid particles may be porous, having interconnected porosity or closed-cell porosity, or nonporous.

An amount of filter aid in a filter layer may be none, or an amount that is desired to provide a desired filtering effect based on a position along a depth of a stack of layers of a depth filter. A filter aid may be present in a filter layer in an amount in a range from 0 or 0.5 to 80 weight percent filter aid based on total weight fiber and filter aid, e.g., from 15 or 25, up to 80 weight percent filter aid based on total weight fiber and filter aid. An amount of filter aid based on total weight fiber and filter aid can be greater in filter layers that are located at downstream positions in a filter layer stack, and can be lower in filter layers that are located at upstream positions in the filter layer stack.

These amounts may also vary depending on whether the filter layer is part of a primary filter or a secondary filter, and whether the filter layer is upstream or downstream in a depth filter. Layers of primary filters will have a lower amount of filter aid per total amount of fiber and filter aid. For example, layers of a primary filter may have from 0 to 60 weight percent filter aid, based on total weight fiber and filter aid in the layer. Layers that are located upstream in a primary depth filter stack will have lower amounts of filter aid, and layers that are located downstream in the stack will have higher amounts of filter aid.

According to certain specific examples of filter arrangements, layers of secondary filters may have higher amounts of filter aid per total amount of fiber and filter aid, compared to layers of primary filters. For example, a layer of a secondary filter may have from 40 to 80 weight percent filter aid based on total weight fiber and filter aid in the layer. According to these and other examples, layers of filters that are located upstream in a secondary filter stack may have lower amounts of filter aid, and layers that are located downstream in the stack may have higher amounts of filter aid. In alternate examples, a downstream layer of a filter may have a higher amount of filter aid compared to an upstream layer.

Polymeric binder (or “binder” for short) is used in a layer of a depth filter to bond the fiber and filter aid into a mechanically stable, porous filter layer. Preferred binders are water-soluble thermosettable polymers that can be dissolved in water and combined with other ingredients of a layer of a depth filter (fiber, filter aid) and subsequently may be chemically cured (e.g., polymerized) to form a polymer that binds the fiber and filter aid together in the form of a useful filter layer. The polymeric binder can include multiple different molecular polymer ingredients, including an optional reactive ingredient referred to as a “crosslinker.” A crosslinker includes two or more reactive groups that can react with larger polymer molecules of the binder to increase a level of intermolecular or intramolecular joining of the larger polymer molecules.

The polymeric binder can be prepared for adding to the other ingredients of a filter layer by being combined with water to form an aqueous liquid that contains the polymer either dissolved in or dispersed in water. The aqueous liquid can be combined with the fiber and filter aid in any manner, and formed into a layer of a depth filter as described.

Examples of polymer resins that are useful as binders as described include water-soluble synthetic polymers with anionic or cationic groups, that can be reacted to form a polymeric network that will impart strength to a filter layer. Suitable resins include urea- or melamine-formaldehyde based polymers, polyaminopolyamide-epichlorohydrin (PAE) polymers and glyoxalated polyacrylamide (GPAM) resins. Commercial resins are readily available from Ashland, Inc. (formerly Hercules Inc.), The Dow Chemical Company, BASF Corporation, Solenis, Nittobo Medical, and Georgia-Pacific Chemicals LLC. Examples of crosslinkers that may be useful with various polymer resins as described include epoxide crosslinkers.

An amount of binder in a filter layer may be an amount that is useful to hold together the other materials of the depth filter, including fiber, filter aid, or both. Binder may be present in a filter layer in an amount in a range from 0.1, 0.2, or 0.5, up to 10 weight percent binder based on total weight fiber and filter aid, e.g., from 1 to 5 weight percent binder based on total weight fiber and filter aid.

A depth filter can contain multiple layers, e.g., 2, 3, 4, 5, or more layers, each layer having different (but possibly overlapping) filtering properties, especially pore size of a filter layer. The layers are arranged in a stack in an order that results in a pore size gradient in a direction of the depth of the depth filter.

A depth filter of the present description will contain at least one layer that contains polyaramid, synthetic filter aid, and binder. Example depth filters may contain two or three layers that contain polyaramid, synthetic filter aid, and binder, with each of the two or three different layers having a different pore size feature, such as different average pore size, different pore size distributions, or both. Example depth filters may additionally contain a layer that contains polyaramid, binder, but no synthetic filter aid.

Example depth filters may also include a layer that is a “non-woven” layer that contains a non-woven fibrous material with no filter aid. Nonwoven materials are broadly defined as sheet or web structures made from entangling fibers or filaments (or by perforating a film) mechanically, thermally, or chemically. A non-woven material is a flat, flexible, porous sheet from separate polymeric fibers or from molten plastic or plastic film. Non-woven materials are not made by weaving or knitting and do not require a step of converting fibers to yarn.

Varieties of nonwoven products are commercially sold that are made from different materials, ranges of fiber sizes (diameters), ranges of basis weights, thicknesses, and pore size ratings. Nonwoven materials can be produced by various technologies such as meltblown, airlaid, spunbond, spunlace, thermal bond, electrospinning and wetlaid. Nonwovens can be made from polymers, inorganic materials, metallic materials, or natural fibers. Suitable materials include polyesters, coated polyesters, polyethylene, polyaramid, coated polyaramid, polyacrylonitrile, carbon, and glass. Depending on desired properties, fiber diameters can range from about 1 nanometer (nm) to about 1 millimeter (mm). Typical fiber diameters may be within a range between about 10 nm and 30 microns (µm).

A basis weight of a non-woven material is defined as the weight of a material per given area. Examples of useful basis weights may be in a range from 5 to 800 g/m², such as in a range from 200 to 600 g/m². A non-woven membrane may have any useful thickness, such as in a range from 50 µm to about 1 centimeter (cm), such as from 0.1 to 0.5 cm.

According to useful examples, layers of a depth filter are arranged such that the pore size of each layer is gradually reduced along the depth of the depth filter in the downstream direction, i.e., average pore size of each layer is greatest at a first upstream layer, each layer in the downstream direction has a smaller pore size, and a final layer in the downstream direction has the smallest pore size of the layers of the depth filter.

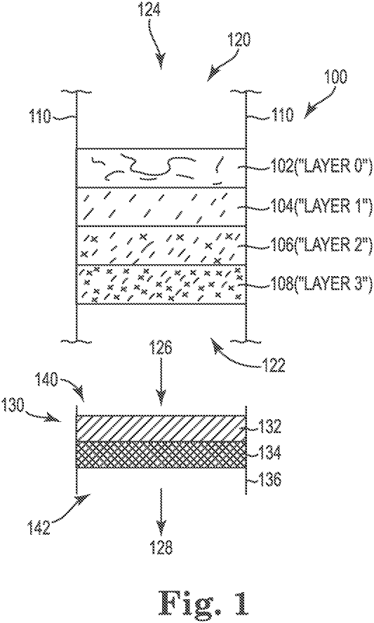

FIG. 1 shows an example of a multi-layer depth filter as described. Depth filter 100 includes housing 110 having inlet 120 and outlet 122. A liquid 124 enters inlet 120, which is upstream from a series of filter layers 102, 104, 106, and 108. The liquid passes through the series of filter layers by first passing through a first (most upstream) layer 102, then through layer 104, then layer 106, and then through the final (most downstream) layer 108. After passing through filter layer 108 the liquid exits housing 110 by passing through outlet 122 as filtrate 126.

In this example, layer 102 (“layer 0”) is a non-woven filter layer, preferably made of gamma-radiation-stable material such as polyester. The second layer 104 (“layer 1”) contains polyaramid fiber and binder and does not require any filter aid. This layer 1 (104) has pores of an average pore size that is smaller than the average pore size of layer 0 (102). The third layer 106 (“layer 2”) contains polyaramid fiber, filter aid, and binder. This layer 2 (106) has pores of an average pore size that is smaller than the average pore size of layer 1 (104). The fourth filter layer 108 (“layer 3”) contains polyaramid fiber, filter aid, and binder. This layer 3 (108) contains a higher amount of filter aid than the amount of filter aid in layer 2 (106), and has pores of an average pore size that is smaller than the average pore size of layer 2 (106).

Optionally, to provide additional adsorption capabilities, the nonwoven material of filter layer 0 (102) may be coated with a polymer resin, e.g., a “binder” polymer as described previously herein, using a known coating method such as dipcoating or spraying.

Some example depth filters include a primary filter positioned in an upstream position and a secondary filter that is positioned downstream from the primary filter. The primary filter may include 2, 3, or 4 filter layers, including a non-woven layer. The secondary filter is a filter that is positioned downstream from a primary filter and may include 1, 2, or 3 or more filter layers that include fiber, filter aid, and binder, with pore sizes that are smaller than pore sizes of the layers of the primary filter.

Referring to FIG. 1, depth filter 100 of FIG. 1, containing layers 0, 1, 2, and 3, may be considered a primary depth filter. FIG. 1 also shows secondary depth filter 130, which includes two additional filter layers 132, 134, in housing 136. Housing 136 includes inlet 140 and outlet 142. Filter layers 132 and 134 can each be a filter layer that includes polyaramid fiber, synthetic filter aid, and binder. Layer 132 of secondary filter 130 contains a higher amount of filter aid than the amount of filter aid in layer 3 (108) of primary depth filter 100, and has pores of an average pore size that is smaller than the average pore size of layer 3 (108). Layer 134 of secondary filter 130 contains a higher amount of filter aid than the amount of filter aid in layer 132 of secondary depth filter 130, and has pores of an average pore size that is smaller than the average pore size of layer 132.

Secondary filter 130 can be used as a filtering step to remove unwanted material from liquid filtrate 126, which is the product of a step of filtering liquid 124 through filter 100. Filtrate 126 liquid enters inlet 140 of secondary filter 130. Inlet 140 is upstream from filter layers 132 and 134. Filtrate 126 passes through filter layer 132, then through filter layer 134, then exits housing 136 by passing through outlet 142 as secondary filtrate 128.

A layer that contains polyaramid fiber, binder, and filter aid, can be prepared by a “wet-laid” method. By this technique, an aqueous slurry is prepared by dispersing the fiber, filter aid, and binder into water to form a substantially homogeneous slurry that can be “wet-laid” onto a flat surface and then dried in a manner to produce a uniform filter layer. To form the slurry, the fiber, filter aid, and binder are combined and then the solids are uniformly dispersed or suspended into the aqueous liquid by any useful method, such as by use of a blender, to form a homogeneous slurry. The slurry can then be laid onto a filtering mesh support that allows gravity draining to remove a substantial amount of water from the slurry to form a homogeneous layer of the solids on a top surface of the mesh support. Residual amounts of water can then be removed by vacuum filtration and drying at a useful (e.g., elevated) temperature for a necessary amount of time.

To prepare a filter layer by a wet-laid technique, the ingredients must be capable of forming a substantially homogeneous suspension that remains homogeneous and stable for an amount of time that is sufficient to allow the slurry to be prepared and then applied to a mesh support, with the applied slurry producing a homogeneous wet-laid filter layer upon removal of the water of the slurry.

The Applicant has determined that polyaramid fibers are capable of forming an aqueous slurry, along with filter aid particles, that is sufficiently homogeneous and stable to allow the slurry to be processed by a wet-laying step and produce a substantially uniform wet-laid filter layer. The Applicant has determined that unlike certain other polymeric fibers, polyaramid fibers have physical properties, especially density, that allow the fibers to be formed with filter aid particles into a homogeneous slurry that is capable of being formed into a filter layer as described by a wet-laying technique.

A useful slurry contains a collection of a large number of the fibers and the filter aid particles in a substantially uniform suspension, with filter aid particles and fibers being relatively uniformly distributed throughout the slurry. In contrast, a slurry that is not considered uniform or homogeneous, or effective to form a wet-laid layer, will include some form of non-homogeneity within the suspension. A non-homogeneity may be a visible separation of fibers and filter aid particles based on a difference in density between the fibers and the filter aid particles. In a non-homogeneous suspension, for example, lower-density polymeric fibers may collect or float at a top portion of a suspension while higher density filter aid particles collect or settle at a lower portion of the suspension. This separation within the slurry prevents the slurry from being used in a wet-laying step to form a uniform filter layer from the slurry.

A useful slurry can contain any useful amounts of fibers, filter aid particles, binder, and water. Example slurries can contain: from 95 to 99.9 weight percent water and from 0.1 to 5 weight percent solids. The solids can contain from 20 to 100 weight percent polyaramid fiber, from 0 to 80 weight percent synthetic filter aid particles, and from 0.5 to 5 weight percent binder, based on a total amount of solids, or based on a total amount of polyaramid fiber and synthetic filter aid.

In example methods, fiber and filter aid (if used) are added to a blender with water. The mixture is blended until uniform, then poured onto a mesh screen where the liquid drains by gravity and forms a wetlaid pad. Separately, binder is dispersed in an amount of water that is sufficient to have the pad fully submerged, and sodium hydroxide is added to the binder solution to activate curing. The solution with the binder may be poured over the (still-wet) pad and allowed to gravity drain. Vacuum is applied to remove residual liquid, then the pad is transferred to the oven for drying (and setting the binder). Alternately, the binder could be added to the slurry during blending, or may be sprayed onto the still-wet, wetlaid pad instead of being poured onto the wetlaid pad.

If desired, the dried filter may be pre-flushed to remove residual materials. For example, before use, the filter is flushed with deionized water at 600 liters per square meter per hour for 10 min, and samples of the filtrate are collected at designated intervals to analyze for total organic carbon. Alternatively, to minimize the volume of water flush required, the filter may be flushed with deionized water at some lower flux for 5 min, then recirculate the filtrate to the inlet for 15 min, and finally flush with fresh deionized water for 5 min, collecting the final 5 min filtrate in fractions for total organic carbon analysis.

The Applicant has determined that a useful or preferred slurry for a wet-laying step as described can be formed by using fibers and filter aid particles that have particle densities that are sufficiently similar to prevent the fibers and the filter aid particles from becoming separated, e.g., stratified, within a slurry, i.e., that are sufficiently similar to allow the fibers and the filter aid particles to remain homogeneously dispersed and suspended within the slurry for an amount of time that allows the slurry to be wet-laid to form a filter layer. Useful or preferred time periods within which a slurry may remain substantially homogeneous for wet-laying, e.g., without showing visible separation or stratification of fibers or filter aid particles within the slurry, may be a period of at least 5, 10, 30, 60, or 120 minutes.

Useful or preferred fibers may have a particle density (i.e., the density of the material used to form the particle, e.g., polyaramid) that is at least 1.2, 1.3 or 1.4 grams per cubic centimeter. Polyaramid, and polyaramid particles, have a density (“particle density” for the polyaramid particles) of approximately 1.44 grams per cubic centimeter. Fibers having a density within a range as described have been found to form stable slurries in combination with various filter aid particles having particle densities of greater than 2.0 grams per cubic centimeter (for example, calcium silicate has a particle density of approximately 2.3 grams per cubic centimeter, and silica has a particle density of approximately 2.4 grams per cubic centimeter).

In contrast, lower density (below 1.2 grams per cubic centimeter) fibers are more difficult or are not able to be formed into a slurry that is stable as described. Polyethylene particles have a particle density of approximately 0.96 grams per cubic centimeter. When combined with water and filter aid (e.g., silica), polyethylene fiber particles did not form stable, homogeneous slurries, but produced stratified suspensions that included concentration gradients of the filter particles and the filter aid particles.

### Example 1

Example depth filters were prepared as described, by stacking a series of filter layers that contain polyaramid fiber and calcium silicate filter aid, with binder. The layers were stacked to exhibit gradually higher amounts of filter aid and to provide gradient pore size distribution from larger to smaller pores in an upstream-to-downstream direction of flow through the layers.

To prepare each layer, polyaramid fiber was blended with water, calcium silicate, and a combination of a PAE binder (“PAE1,” polyaminopolyamide-epichlorhydrin polymer) and epoxide crosslinker (“EC”). A few drops of concentrated sodium hydroxide were added to activate the binder. The slurry was drained into a tube with a 4” diameter mesh screen and the formed pad was evacuated to remove excess liquid, then dried at 90° C. for two hours. The primary depth filter was made using four filter layers, while the secondary filter included two filter layers (see below). For challenge testing, 47 mm discs were punched out of the pads and sealed into reusable device holders.

A previously frozen CHO-S cell culture (311 NTU) was loaded into the primary filter at 100 L/m2/h and filtrates were collected at 15 min intervals for turbidity measurements. Methods for measuring turbidity of a filtrate, and for measuring pressure drop across a filter, are known. Turbidity was measured with an Oakton T-100 turbidity meter.

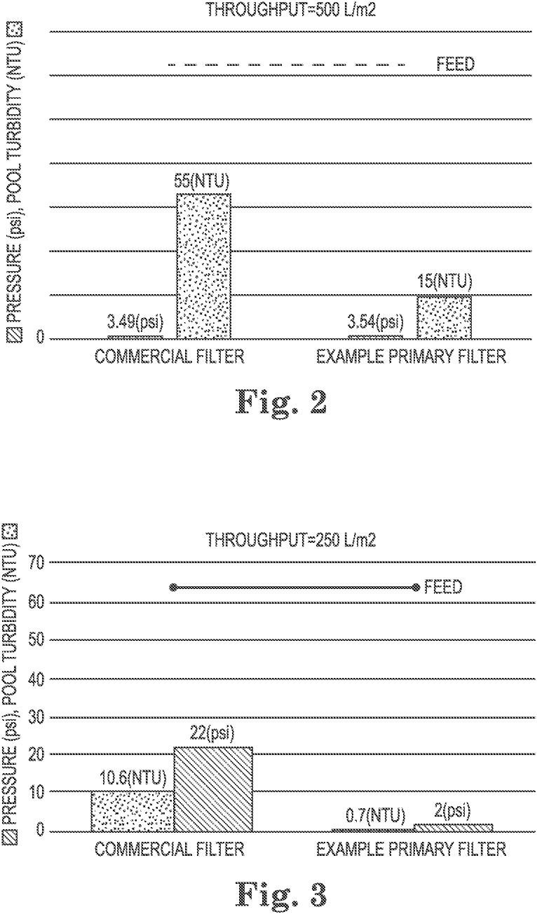

After 500 L/m² throughput, the turbidity of the filtrate pool (“pool turbidity”) was 15 NTU and the pressure drop was 3.5 psi. This is shown at FIG. 2. For comparison, a commercially available depth filter (Millpore Millistak+® HC Pro D0SP), after the same test flow, had a pool turbidity of 55 NTU and a pressure drop of 3.5 psi. The inventive filter produced a more clarified filtrate.

The filtrates from the primary filtration experiment above were pooled (64 NTU) and used as the challenge for the secondary filters. At 250 L/m², the inventive filter had a pool turbidity of 0.7 NTU and a pressure drop of 2 psi, while the competitive filter (Millipore Millistak+® HC X0HC) had a pool turbidity of 10.6 NTU and a pressure drop of 22 psi. This is shown at FIG. 3. The inventive filter produced a more clarified filtrate.

The primary filter is composed of 4 layers:
1. PET nonwoven (400 gsm, 2 mm thick).
2. 2.73 g HP100 (polyaramid fiber from Kolon), 0.12 PAE1 (first binder), 0.21 g EC (second binder).
3. 1.96 g HP100, 0.17 g PAE1, 0.30 g EC, 1.96 g calcium silicate D.
4. 2.45 g HP300 (polyaramid fiber from Kolon), 0.14 g PAE1, 0.24 g EC, 0.82 g calcium silicate T.

The secondary filter is composed of 2 layers:
1. 2.65 g HP300, 0.18 g PAE1, 0.31 g EC, 1.42 g calcium silicate T.
2. 0.97 g K544 (Kevlar® polyaramid fiber), 1.94 g HP300, 0.15 g PAE1, 0.26 g EC, 0.51 g calcium silicate T.

### Example 2

Various examples of primary and secondary depth filters were prepared as below.

Sample 2A is an example of a 5-layer depth filter having: a first (upstream) layer made of polyaramid (Kevlar®) that is coated with two types of thermosetting polyaminopolyamide-epichlorohydrin polymers (“PAE2” and “PAE3”) (these types of polymers being designated with the “PAE” designation); a second layer made of a polyester non-woven material; a third layer made with wetlaid polyaramid (Twaron® 1092), PAE polymer (“PAE1”) and epoxide crosslinker (“EC”); and fourth and fifth layers each made from wetlaid polyaramid (two types), polyaminopolyamide-epichlorhydrin polymer (“PAE1”) and epoxide crosslinker (“EC”), and calcium silicate (Micro-Cel™ T-38).

Sample 2B is an example of a 4-layer depth filter having: a first (upstream) layer made from polyester non-woven material; a second layer made with wetlaid polyaramid (Twaron 1092) and a combination of PAE polymer with epoxide crosslinker (EC); and third and fourth layers each made from wetlaid polyaramid, PAE polymer, epoxide crosslinker (EC), and calcium silicate synthetic filter aid (e.g., Florite R®, or Micro-Cel T-38).

Sample 2C is an example of a 3-layer depth filter having each layer made from wetlaid polyaramid, PAE polymer and epoxide crosslinker (EC), and synthetic filter aid (activated carbon, or Micro-Cel T38, or Zeopharm® 250).

Sample 2D is an example of a 2-layer depth filter having each layer made from wetlaid polyaramid (two types), PAE polymer, epoxide crosslinker (EC), and synthetic filter aid.

| Sample | Type | layers |
|---|---|---|
| 2A | Primary | 1. Kevlar nonwoven (542 gsm, 6 mm thick) coated with 2.5% PAE2 and 2.5% PAE3. 2. polyester nonwoven (544 gsm, 2 mm thick) 3. 17.36 g Twaron 1092, 0.26 g PAE1, 0.46 g EC 4. 7.16 g Twaron 1092, 0.57 g Twaron 1094, 0.17 g PAE1, 0.30 g EC, 1.28 g Micro-Cel T-38. 5. 5.97 g Twaron 1092, 1.49 g Twaron 1094, 0.23 g PAE1, 0.40 g EC, 2.69 g Micro-Cel T-38. |
| 2B | Primary | 1. polyester nonwoven (400 gsm, 2 mm thick) 2. 17.36 g Twaron 1092, 0.26 g PAE1, 0.46 g PAE2 |
| | | 3. 8.72 g Twaron 1092, 0.71 g Twaron 3094, 0.21 g PAE1, 0.38 g EC, 1.6 g Florite R. 4. 5.4 g Twaron 1092, 1.8 g Twaron 1094, 0.19 g PAE1, 0.32 g EC, 1.73 g Micro-Cel T-38. |
| 2C | Secondary | 1. 2.1 g Twaron 1092, 4.4 g Twaron 1094, 0.34 g PAE1, 0.59 g EC, 5.48 g Fisher C272 activated carbon. 2. 3.22 g Twaron 1092, 6.44 g Twaron 1094, 0.33 g PAE1, 0.58 g EC, 4.25 g Micro-Cel T-38. 3. 4.46 g Twaron 1092, 4.46 g Twaron 1094, 0.37 g PAE1, 0.64 g EC, 5.4 g Zeopharm 250. |
| 2D | Secondary | 1. 6.4 g Twaron 1092, 3.2 g Twaron 1094, 0.33 g PAE1, 0.58 g EC, 4.25 g Micro-Cel T-38. 2. 5.32 g Twaron 1092, 2.66 g Twaron 1094, 0.33 g PAE1, 0.57 g EC, 4.79 g Micro-Cel T-38. |

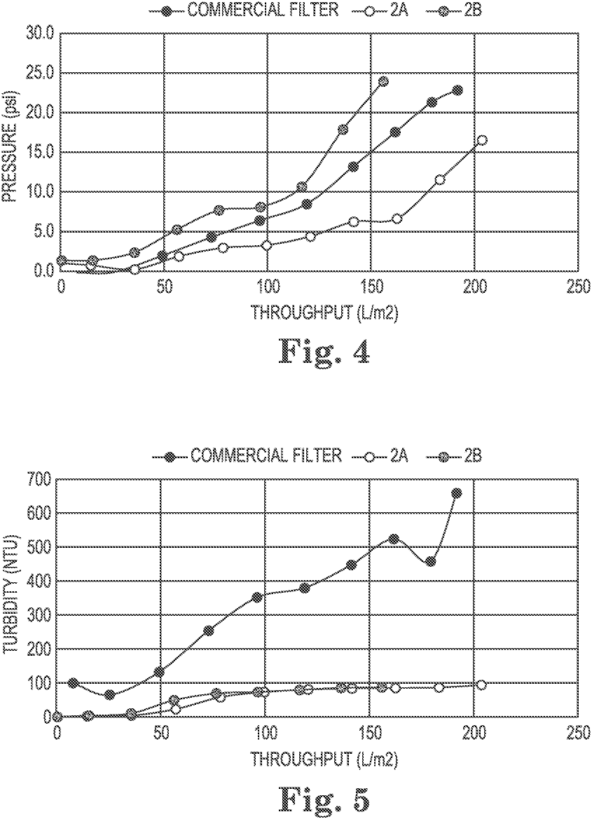

A CHO-S cell culture (36 x 10⁶ cells/mL, 64.4% viability, 2158 NTU) was loaded into the primary filters at 125 L/m²/h and filtrates were collected at 10 min intervals for turbidity measurements. FIGS. 4 and 5 show the pressure and turbidity profiles of the two example primary filters 2A and 2B, along with pressure and turbidity profiles of a commercially available primary depth filter (Millipore’s Millistak+® HC Pro D0SP) for comparison. Filter 2A had the highest throughput, lowest turbidity, and lowest pressure drop, exhibiting much better overall performance than the commercial filter. Filter 2B had slightly higher pressure drop, slightly lower throughput, but significantly lower turbidity than the commercial filter.

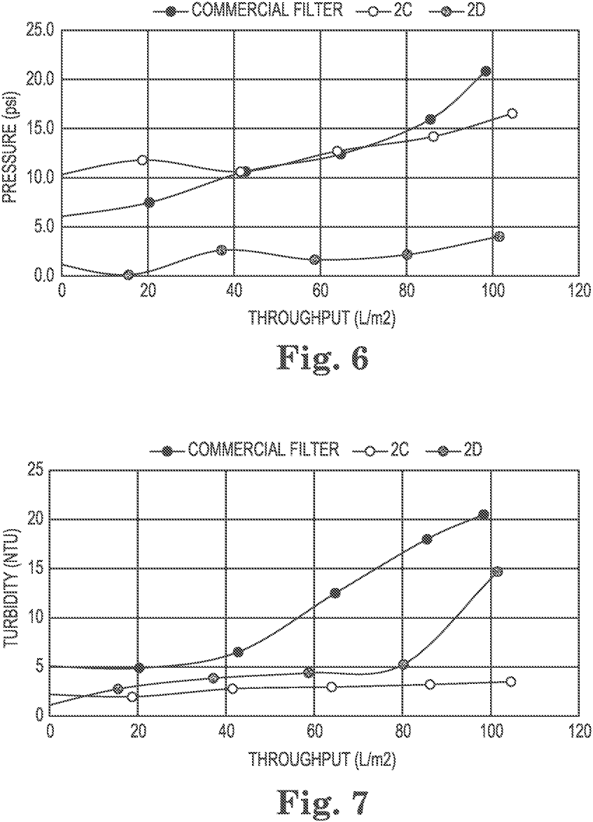

The filtrates from primary filters 2A and 2B were then combined and used as the challenge for example secondary filters 2C and 2D. The starting turbidity was 128 NTU. FIGS. 6 and 7 show the pressure and turbidity profiles of the secondary filters along with a commercially available (Millipore’s Millistak+® HC Pro X0SP) secondary depth filter for comparison. At similar throughputs, example secondary filters 2C and 2D exhibited similar or lower pressure drop, and significantly better turbidity.

### Example 3

Sample 3A is an example of a 4-layer primary depth filter having: a first (upstream) layer made of polyester non-woven material; a second layer made with wetlaid polyaramid (Twaron 1092) and PAE polymer (“PAE1”) and epoxide crosslinker (“EC”); and third and fourth layers each made from wetlaid polyaramid polyaminopolyamide-epichlorhydrin polymer (“PAE 1”) and epoxide crosslinker (“EC”), and calcium silicate (Micro-Cel T-38).

Sample 3B is an example of a 5-layer primary depth filter having: a first (upstream) layer made of polyester non-woven material; a second layer made with wetlaid polyaramid (Twaron 1092) and PAE and EC; and third, fourth, and fifth layers made with wetlaid polyaramid (Twaron 1092 and Twaron 1094), PAE and EC, and calcium silicate.

Sample 3C is an example of a 2-layer secondary depth filter having each layer made from wetlaid polyaramid (two types), PAE and EC, and calcium silicate as synthetic filter aid.

Sample 3D is an example of a 2-layer secondary depth filter having each layer made from wetlaid polyaramid (two types), PAE and EC polymers, and calcium silicate as synthetic filter aid.

| Sample | Type | layers |
|---|---|---|
| 3A | Primary | 1. polyester nonwoven (400 gsm, 2 mm thick) 2. 17.36 g Twaron 1092, 0.26 g PAE1, 0.46 g EC 3. 7.26 g Twaron 1092, 0.73 g Twaron 1094, 0.16 g PAE1, 0.29 g EC, 0.96 g Micro-Cel T38 4. 5.97 g Twaron 1092, 1.49 g Twaron 1094, 0.23 g PAE1, 0.40 g EC, 2.69 g Micro-Cel T38 |
| 3B | Primary | 1. polyester nonwoven (350 gsm, 1.7 mm thick) 2. 17.36 g Twaron 1092, 0.26 g PAE1, 0.46 g EC 3. 8.27 g Twaron 1092, 0.83 g Twaron 1094, 0.14 g PAE1, 0.25 g EC 4. 7.16 g Twaron 1092, 0.57 g Twaron 1094, 0.17 g PAE1, 0.30 g EC, 1.28 g Micro-Cel T38 5. 5.97 g Twaron 1092, 1.49 g Twaron 1094, 0.23 g PAE1, 0.40 g EC, 2.69 g Micro-Cel T38 |
| 3C | Secondary | 1. 4.83 g Twaron 1092, 4.83 g Twaron 3094, 0.33 g PAE1, 0.57 g EC, 4.25 g Micro-Cel T38 2. 3.99 g Twaron 1092, 3.99 g Twaron 3094, 0.33 g PAE1, 0.57 g EC, 4.79 g Micro-Cel T38 |
| 3D | Secondary | 1. 7.73 g Twaron 1092, 1.93 g Twaron 1094, 0.33 g PAE1, 0.57 g EC, 4.25 g Micro-Cel T38 2. 2.10 g Twaron 1092, 4.20 g Twaron 1094, 0.33 g PAE1, 0.58 g EC, 5.29 g Micro-Cel T38 |

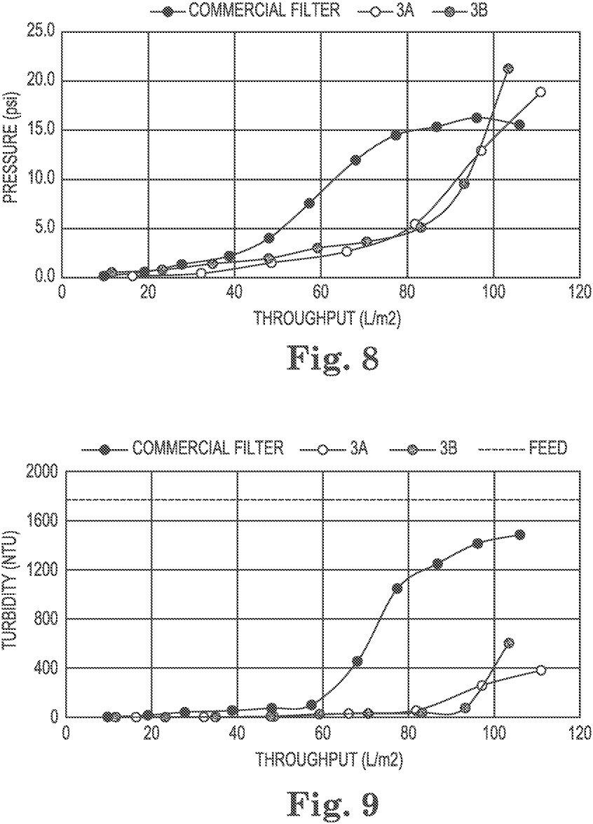

A CHO-S cell culture (8 x 10⁶ cells/mL) was processed through a Millipore Pellicon 30 kDa membrane to concentrate the solution to 22.4 x 10⁶ cells/mL at 88% viability, which was then loaded into the primary filters at 140 L/m²/h. Filtrates were collected and tested for turbidity. FIGS. 8 and 9 show the pressure and turbidity profiles of the primary filters along with a commercially available primary depth filter for comparison. At -100 L/m², all 3 filters had similar pressure drops, but Filter 3A and Filter 3B had much lower turbidity than the commercial filter (Millipore’s Millistak+® HC Pro D0SP).

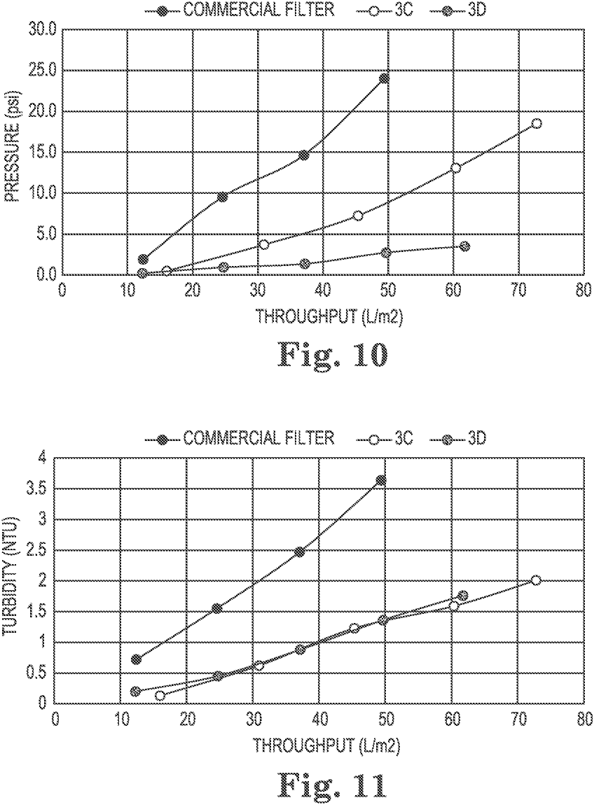

The filtrates from the primary filters were then pooled and used as the challenge for the secondary filters. The starting turbidity was 307 NTU. FIGS. 10 and 11 show the pressure and turbidity profiles of the secondary filters along with a commercially available secondary depth filter for comparison. Inventive Filter 3C and Filter 3D had higher throughput, lower pressure drop, and lower turbidity than the commercial filter (Millipore’s Millistak+® HC Pro X0SP), exhibiting much better overall performance.

### Examples

In a first aspect, a depth filter comprises: two or more layers, in series, wherein at least one layer that comprises polyaramid fiber, synthetic filter aid, and polymeric binder.

A second aspect according to the first aspect, wherein the at least one layer comprises fiber matrix comprising entangled polyaramid fibers, synthetic filter aid particles distributed throughout the fiber matrix, and binder that bonds together the polyaramid fibers and the synthetic filter aid particles.

A third aspect according to any of the preceding aspects further comprises: from 20 to 99.5 weight percent polyaramid fiber, from 15 to 80 weight percent synthetic filter aid, and from 0.5 to 5 weight percent binder, based on total weight fiber and filter aid.

A fourth aspect according to any of the preceding aspects, wherein at least a portion of the polyaramid fibers are fibrillated.

A fifth aspect according to any of the preceding aspects, wherein the synthetic filter aid comprises a metal silicate, activated carbon, or a combination thereof.

A sixth aspect according to any of the preceding aspects, the synthetic filter aid comprising magnesium silicate, calcium silicate, or a combination thereof.

A seventh aspect according to any of the preceding aspects, wherein the polymeric binder comprises polymer selected from: a urea polymer, a melamine-formaldehyde polymer, polyaminopolyamide-epichlorohydrin polymer, glyoxalated polyacrylamide polymer, or a combination thereof, with optional epoxide crosslinker.

An eighth aspect according to any of the preceding aspects, further comprising three stacked layers: a first layer comprising polyaramid fiber and thermoset polymeric binder, a second layer comprising polyaramid fiber, thermoset polymeric binder, and synthetic filter aid, a third layer comprising polyaramid fiber, thermoset polymeric binder, and synthetic filter aid, wherein: the second layer is located between the first layer and the third layer, the second layer contains an amount (weight percent) of synthetic filter aid (weight percent), the third layer contains an amount (weight percent) of synthetic filter aid, and the amount (weight percent) of synthetic filter aid in the third layer is greater than the amount (weight percent) of synthetic filter aid in the second layer.

A ninth aspect according to the eighth, further comprising a fourth layer, the fourth layer comprising a synthetic non-woven material.

A tenth aspect according to the ninth aspect, wherein the synthetic non-woven material comprising polyaramid, coated polyaramid, polyester, or coated polyester.

An eleventh aspect according to any of the preceding aspects, further comprising the two or more layers in series assembled at an interior of a filter housing, the layers and the filter housing sterilized by exposure to gamma radiation.

A twelfth aspect is directed to a method of removing particles of different sizes from a fluid, the method comprising passing the fluid through a depth filter of any of the preceding aspects.

A thirteenth aspect according to the twelfth aspect, wherein the fluid contains particles having a size range from 0.2 microns to 25 microns.

A fourteenth aspect according to the twelfth or thirteenth aspect, further comprising passing the fluid through the depth filter to remove cellular debris from the fluid.

A fifteenth aspect is directed to a method of forming a wet-laid filter material, the method comprising: forming a slurry comprising aqueous liquid, polyaramid fiber, synthetic filter aid, and binder, suspended throughout the aqueous liquid, forming a wet slurry layer from the slurry, and removing the aqueous liquid from the wet slurry layer to form a dewatered wet-laid filter material.

A sixteenth aspect according to the fifteenth aspect, wherein the binder is a water soluble thermosetting binder, the method comprising adding base to the slurry and heating the wet-laid filter layer to polymerize the binder.

A seventeenth aspect according to the fifteenth or sixteenth aspect, wherein the slurry comprises: from 95 to 99.9 weight percent water, based on total weight slurry, from 0.1 to 5 weight percent solids, the solids comprising: from 20 to 100 weight percent polyaramid fibers, from 0 to 80 weight percent filter aid particles, and from 0.5 to 5 weight percent binder, based on total weight fiber and filter aid.

1. A depth filter comprising:
two or more layers, in series,
wherein at least one layer comprises polyaramid fiber, synthetic filter aid, and polymeric binder.

2. The depth filter of claim 1, the at least one layer comprising:
fiber matrix comprising entangled polyaramid fibers,
synthetic filter aid particles distributed throughout the fiber matrix, and
polymeric binder that bonds together the polyaramid fibers and the synthetic filter aid particles.

3. The depth filter of claim 1, further comprising:
from 20 to 99.5 weight percent polyaramid fiber,
from 0.5 to 80 weight percent synthetic filter aid, and
from 0.5 to 5 weight percent binder, based on total weight fiber and filter aid.

4. The depth filter of claim 1, wherein at least a portion of the polyaramid fibers are fibrillated.

5. The depth filter of claim 1, wherein the synthetic filter aid comprises a metal silicate, activated carbon, or a combination thereof.

6. The depth filter of claim 1, wherein the synthetic filter aid comprises magnesium silicate, calcium silicate, or a combination thereof.

7. The depth filter of claim 1, wherein the polymeric binder comprises polymer selected from: a urea polymer, a melamine-formaldehyde polymer, polyaminopolyamide-epichlorohydrin polymer, glyoxalated polyacrylamide polymer, or a combination thereof, optionally in combination with epoxide crosslinker.

8. The depth filter of claim 1, further comprising three stacked layers:
a first layer comprising polyaramid fiber and thermoset polymeric binder,
a second layer comprising polyaramid fiber, thermoset polymeric binder, and synthetic filter aid,
a third layer comprising polyaramid fiber, thermoset polymeric binder, and synthetic filter aid,
wherein:
the second layer is located between the first layer and the third layer,
the second layer contains an amount (weight percent) of synthetic filter aid (weight percent),
the third layer contains an amount (weight percent) of synthetic filter aid, and
the amount (weight percent) of synthetic filter aid in the third layer is greater than the amount (weight percent) of synthetic filter aid in the second layer.

9. The depth filter of claim 8, further comprising a fourth layer, wherein the fourth layer comprises synthetic non-woven material.

10. The depth filter of claim 9, wherein the synthetic non-woven material comprises polyaramid, coated polyaramid, polyester, or coated polyester.

11. The depth filter of claim 1, further comprising the two or more layers in series assembled at an interior of a filter housing, the layers and the filter housing sterilized by exposure to gamma radiation.

12. A method of removing particles of different sizes from a fluid, the method comprising passing the fluid through a depth filter of claim 1.

13. The method of claim 12, wherein the fluid contains particles having a size range from 0.2 microns to 25 microns.

14. The method of claim 12, further comprising passing the fluid through the depth filter to remove cellular debris from the fluid.

15. A method of forming a wet-laid filter material, the method comprising:
forming a slurry comprising aqueous liquid, polyaramid fiber, synthetic filter aid, and binder, suspended throughout the aqueous liquid,
forming a wet slurry layer from the slurry, and
removing the aqueous liquid from the wet slurry layer to form a dewatered wet-laid filter material.

16. A method of claim 15, wherein the binder is a water soluble thermosetting binder, the method comprising adding base to the slurry and heating the wet-laid filter layer to polymerize the binder.

17. A method of claim 15, wherein the slurry comprises:
from 95 to 99.9 weight percent water, based on total weight slurry,
from 0.1 to 5 weight percent solids, the solids comprising:
from 20 to 100 weight percent polyaramid fibers,
from 0 to 80 weight percent filter aid particles, and
from 0.5 to 5 weight percent binder,
based on total weight fiber and filter aid.
